(19) United States
(12) Patent Application Publication
(10) Pub. No.: US 2010/0130306 A1
(43) Pub. Date: May 27, 2010

(54) Golf Club Heads with Multiple Materials and Methods to Manufacture Golf Club Heads with Multiple Materials

(76) Inventor: Bradley D. Schweigert, Anthem, AZ (US)

Correspondence Address: KARSTEN MANUFACTURING CORPORATION, LEGAL DEPARTMENT, 2201 WEST DESERT COVE, PHOENIX, AZ, 85029, US

(21) Appl. No.: 12/275,976

(22) Filed: Nov. 21, 2008

(51) Int. Cl. A63B 53/04; B23P 17/00; B23P 11/00

(52) U.S. Cl. 473/350; 473/349; 29/527.5; 29/525.14

(57) ABSTRACT

Embodiments of golf club heads with multiple materials and methods to manufacture golf club heads with multiple materials are generally described herein. Other embodiments may be described and claimed.

### TECHNICAL FIELD

The present disclosure relates generally to golf equipment, and more particularly, to golf club heads with multiple materials and methods to manufacture golf club heads with multiple materials.

### BACKGROUND

Various materials (e.g., steel-based materials, titanium-based materials, tungsten-based materials, etc.) may be used to manufacture golf club heads. By using multiple materials to manufacture golf club heads, the position of the center of gravity and/or the moment of inertia of the golf club heads may be optimized to improve the performance of the golf club heads.

### BRIEF DESCRIPTION OF THE DRAWINGS

FIG. 1 is a perspective diagram representation of an example golf club head according to an embodiment of the methods, apparatus, and articles of manufacture described herein.

FIG. 2 depicts a front view of the example golf club head of FIG. 1.

FIG. 3 depicts a back view of the example golf club head of FIG. 1.

FIG. 4 depicts a top end view of the example golf club head of FIG. 1.

FIG. 5 depicts a sole end view of the example golf club head of FIG. 1.

FIG. 6 depicts a toe end view of the example golf club head of FIG. 1.

FIG. 7 depicts a heel view of the example golf club head of FIG. 1.

FIG. 8 depicts an example body portion associated with the example golf club head of FIG. 1.

FIG. 9 depicts example weight portions associated with the example golf club head of FIG. 1.

FIG. 10 depicts another example golf club head.

FIG. 11 depicts an example face portion associated with the example golf club head of FIG. 10.

FIG. 12 depicts example weight portions associated with the golf club head of FIG. 10.

FIG. 13 depicts one manner in which the example golf club heads described herein may be manufactured.

### DESCRIPTION

In general, grooves of golf club heads with multiple materials and methods to manufacture golf club heads multiple materials are described herein. The apparatus, methods, and articles of manufacture described herein are not limited in this regard.

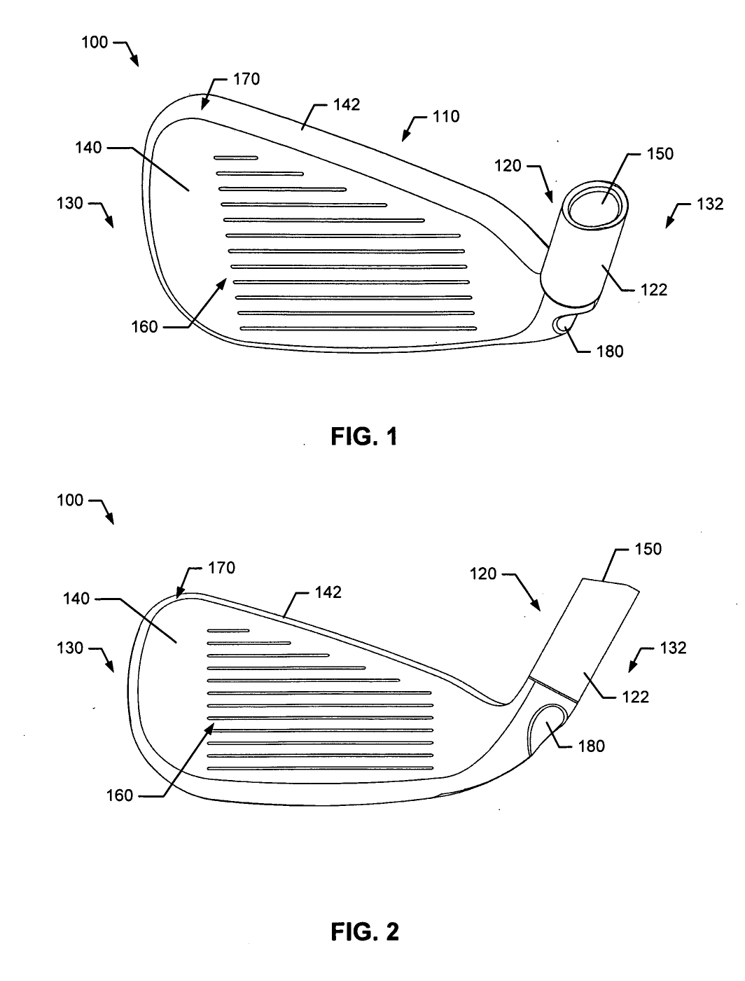

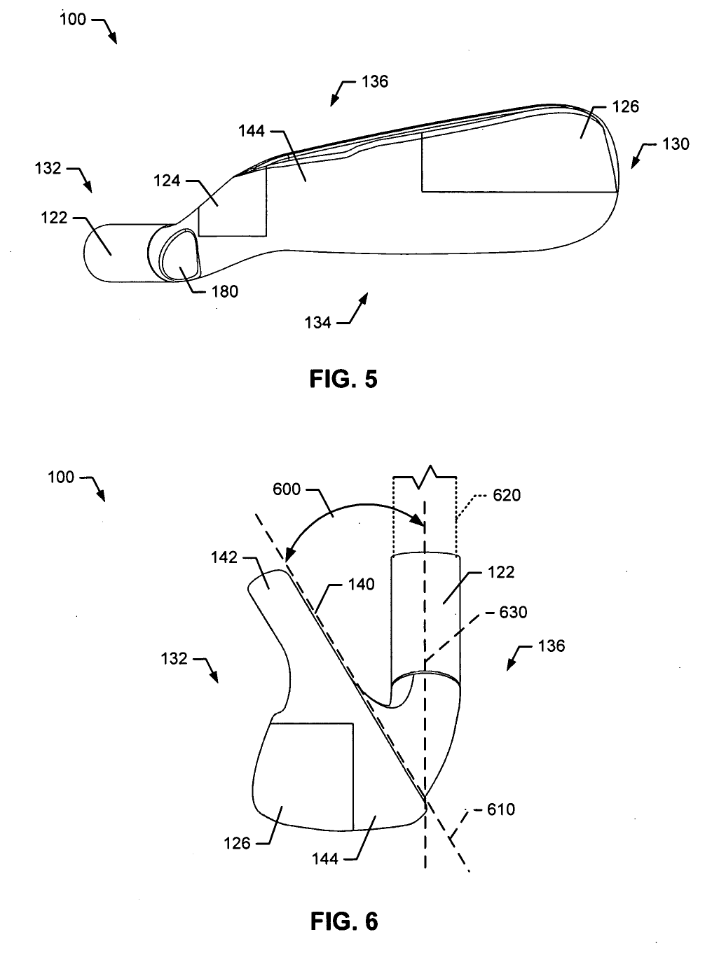

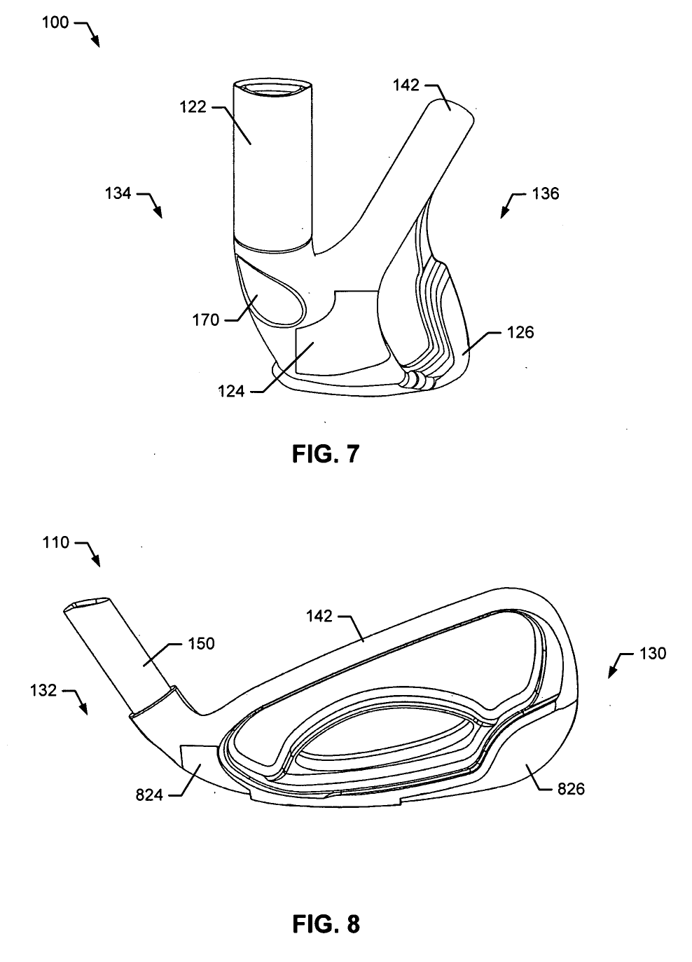

In the example of FIGS. 1-9, a golf club head 100 may a body portion 110, and one or more weight portions 120, generally shown as 122, 124, and 126. The body portion 110 may also include a toe end 130, a heel end 132, a front end 134, a back end 136, a face portion 140, a top rail portion 142, a sole portion 144, a hosel portion 150, and one or more grooves 160, a perimeter weighting portion 170, and a notch 180.

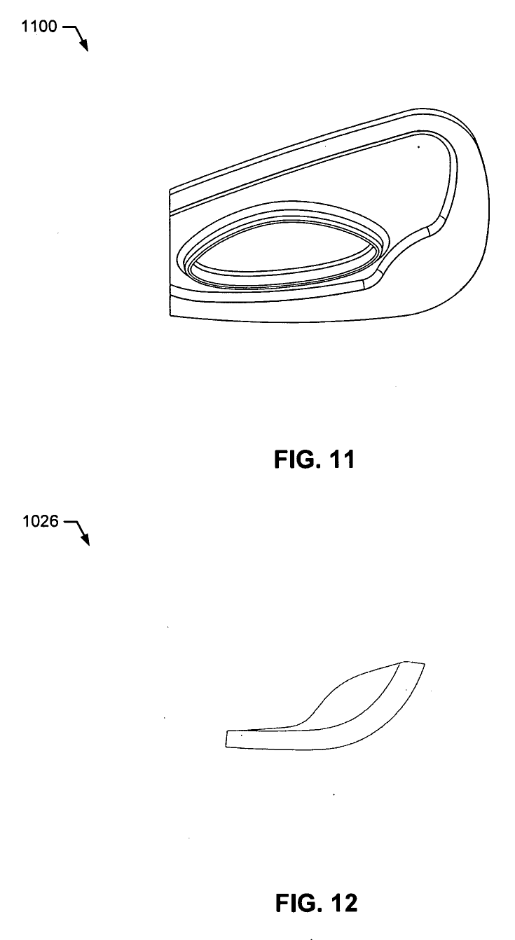

In general, the golf club head 100 may be used to impact a golf ball (not shown) via the face portion 140. The face portion 140 (e.g., a strike face) may be an integral portion of the body portion 110. Alternatively, the face portion 140 may be a separate piece from or an insert for the body portion 110 (e.g., FIGS. 10 and 11). As illustrated in FIG. 6, for example, the golf club head 100 may be associated with a loft angle 600. In particular, the face portion 140 may define a loft plane 610. A shaft 620 inserted into the hosel portion 150 may define a shaft plane 630, which may be associated with an axis of the shaft 620. The loft angle 600 of the golf club head 100 may vary based on the type of club (e.g., a long iron, a middle iron, a short iron, a wedge, etc.). In one example, the loft angle 600 may be between five degrees and seventy-five degrees. In another example, the loft angle 600 may be greater than or equal to ten degrees.

The body portion 110 and the hosel portion 150 may be made of a single piece of metal material (e.g., casting of a steel-based material), two or more different metal materials (e.g., different alloys), or two or more different materials (e.g., metal and non-metal materials such as a steel-based material and a composite material, respectively). The hosel portion 150 may receive an end of a shaft (e.g., one shown as 620 in FIG. 6). In the front end 134 of the golf club head 100, the groove(s) 160 may be located on the face portion 140 and extend between the toe end 130 and heel end 132. The perimeter weighting portion 170 may be defined by the top rail portion 142 and/or the sole portion 144 of the body portion 110. The notch 180 may be located at or proximate to heel end 132. In particular, the notch 180 may be used to adjust loft and lie of the golf club head 100.

Further, the body portion 110 may include a first cavity 190 and a second cavity 195. Both first cavity 190 and the second cavity 195 may located in the back end 136 of the golf club head 100. In particular, the face portion 140 and the perimeter weighting portion 170 may define the first cavity 190. The second cavity 195 may be located within the first cavity 190. For example, the second cavity 195 may be proximate to or form a boundary of the first cavity 190 (e.g., proximate the sole portion 144). Alternatively, the second cavity 195 may be completely separate from any boundary of the first cavity 190. Further, a weight adjustment portion (not shown) may be disposed in the second cavity 195.

The golf club head 100 may include various dissimilar materials such that the body portion 110 and the weight portion(s) 120 may be coupled to each other by a brazing process or other suitable process. The body portion 110 may be made of a steel-based material, a titanium-based material, an aluminum-based material (e.g., a high-strength aluminum alloy or a composite aluminum alloy coated with a high-strength alloy), any combination thereof, and/or other suitable types of material. In one example, the body portion 110 may be made partially or entirely of a titanium-based material. In another example, the body portion 110 may be made partially or entirely of metal materials with high-strength-to-weight ratios. The weight portion(s) 120 may be made of a tungsten-based material or other suitable types of material. In one example, the weight portion(s) 120 may be made partially or entirely of a tungsten-based material. In another example, the weight portion(s) 120 may be made of a material having a specific gravity of at least 15. As described in detail below the weight portion(s) 120 may be located at or proximate to various portions of the body portion 110.

The golf club head 100 may be associated with a total volume (v_{T}) and a total mass (m_{T}). In particular, the body portion 110 may be associated with a first volume (v₁) and a first mass (m₁), and the weight portion(s) 120 may be associated with a second volume (v₂) and a second mass (m₂). The total volume (v_{T}) may include the first volume (v₁) and the second volume (v₂) (e.g., v_{T}=v₁+v₂). The total mass (m_{T}) may include the first mass (m₁) and the second mass (m₂) (e.g., m_{T}=m₁+m₂). The methods, apparatus, and articles of manufacture described herein are not limited in this regard.

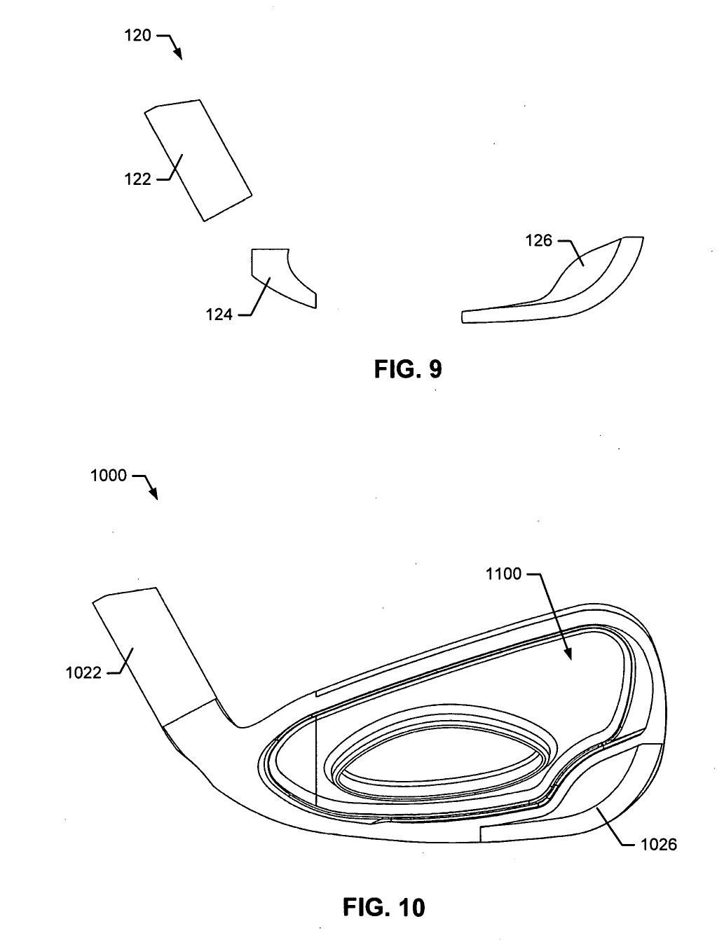

Referring to FIG. 8, for example, the body portion 110 may include the hosel portion 150, and one or more weight recess portions 820, generally shown as a heel end recess 824 and a toe end recess 826. The heel end recess 824 may be at or proximate to the heel end 132 of the body portion 110. The toe end recess 826 may be at or proximate to the toe end 130 of the body portion 110. In one example, the heel end recess 824 and/or the toe end recess 826 may be located at or proximate to the back end 136 of the body portion 110. In another example, the heel end recess 824 and/or the toe end recess 826 may be located at or proximate to the front end 132 of the body portion 110. Alternatively, the heel end recess 824 may be located at or proximate to a middle of the heel end 132 of the body portion 110 and/or the toe end recess 826 may be located at or proximate to a middle of the toe end of the body portion 110.

Turning to FIG. 9, for example, the weight portion(s) 120 may a hosel weight portion 122, and one or more recess weight portions, generally shown as a heel end weight portion 124 and a toe end weight portion 126. In one example, the hosel weight portion 122 may be a cylindrical-shaped weight portion (e.g., a sleeve-like portion) configured to circumscribe the hosel portion 150 of the body portion 110 (FIG. 8). In another example, the hosel weight portion 122 may be coupled to a portion of the hosel portion 150 (e.g., a semi-circular shaped weight portion). In yet another example, the hosel weight portion 122 may be inserted into a recess of the hosel 810. Alternatively, the hosel weight portion 122 may be inserted into a bore of a golf club head (not shown).

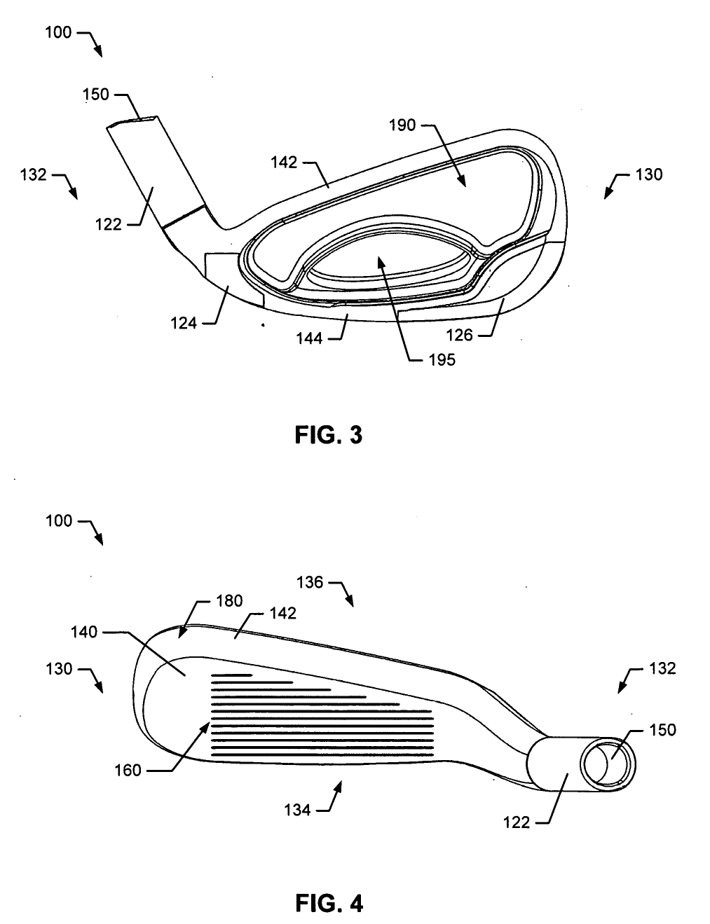

The heel end weight portion 124 may be coupled to the body portion 110 at or within the heel end recess 824 whereas the toe end weight portion 126 may be coupled to the body portion 110 at or within the toe end recess 826. Based on the location of the heel end recess 824 and the toe end recess 826, the heel end weight portion 124 and the toe end weight portion 126 may be visible from various perspectives of the golf club head 100. In one example, the heel end weight portion 124 and the toe end weight portion 126 may be visible from the back end 136 of the golf club head 100 if the heel end recess 824 and the toe end recess 826, respectively, are located at or proximate to the back end 136 (FIG. 3). In another example, the heel end weight portion 124 and the toe end weight portion 126 may be visible from the front end 133 of the golf club head 100 if the heel end recess 824 and the toe end recess 826, respectively, are located at or proximate to the front end 134. In yet another example, the heel end weight portion 124 and the toe end weight portion 126 may be visible from the sole 144 of the golf club head 100 if the heel end recess 824 and the toe end recess 826 are located at or proximate to a middle of the sole 144 on the heel end 132 and the toe end 130, respectively. Alternatively, the heel end weight portion 824 and/or the toe end weight portion 826 may not be visible at all.

As noted above, the body portion 110 and the weight portion(s) 120 may be dissimilar materials. In one example, the body portion 110 may be a titanium-based material whereas the weight portion(s) 120 may be a tungsten-based material. The body portion 110 may be associated with the first volume (v₁) and the first mass (m₁) whereas the weight portion(s) 120 may be associated with the second volume (v₂) and the second mass (m₂). For example, the second volume v₂ (e.g., the total volume of the weight portion(s) 120) may include the volume of the hosel weight portion 122, the volume of the heel end weight portion 124, and the volume of the toe end weight portion 126. The second mass m₂ may include the mass of the hosel weight portion 122, the mass of the heel end weight portion 124, and the mass of the toe end weight portion 126.

While the first volume v₁ may be greater than the second volume v₂ (v₁>v₂), the first mass m₁ may be less than or equal to the second mass m₂ (m₁≦m₂). In one example, the second volume v₂ may be less than or equal to 25% of the total volume v_{T} (e.g., the volume of the club head 100) whereas the second mass m₂ may be greater than or equal to 50% of the total mass m_{T} (e.g., the mass of the club head 100). In another example, the first volume v₁ and the second volume v₂ may be associated with a ratio of 3:1 whereas the first mass m₁ and the second mass m₂ may be associated with a ratio of 1:1 (e.g., the first mass m₁ and the second mass m₂ may be substantially equal to each other).

By coupling the weight portion(s) 120 to the body portion 110, the moment of inertia (MOI) and the location of the center of gravity (CG) of the golf club head 100 may be optimized. In particular, the location of the CG may be lowered towards the sole 144 and further back towards the back end 136 by the weight portion(s) 120. Further, the MOI may be higher as measured about a vertical axis through the CG. As a result, the club head 100 may provide a relatively higher launch angle and/or a relatively lower spin rate trajectory than a golf club head without the weight portion(s) 120. The methods, apparatus, and articles of manufacture described herein are not limited in this regard.

As described in the above examples, the golf club head 100 may include a body portion made of a titanium-based material (e.g., the body portion 110), and one or more weight portion(s) made of a tungsten-based material (e.g., the weight portion(s) 120). Alternatively, the golf club head 100 may include a body portion made of a steel-based material, a face portion made of a titanium-based material, and one or more weight portion(s) made of a tungsten-based material. In the example of FIGS. 10-12, a golf club head 1000 may a body portion 1010, and one or more weight portions 1020, generally shown 1022 and 1026 (e.g., FIG. 12). In one example, the body portion 1010 may be made of a steel-based material by a casting process, and the weight portion(s) 1020 may be made of a tungsten-based material. In contrast to the golf club head 100 as described above (e.g., FIGS. 1-9), the golf club head 1000 may include a face portion 1100 (e.g., FIG. 11) that may be a separate piece from or an insert for the body portion 1010. For example, the face portion 1100 may be a separate piece made of a titanium-based material by a casting process. The body portion 1010 and the face portion 1100 may be coupled to each other by a brazing process. The methods, apparatus, and articles of manufacture described herein are not limited in this regard.

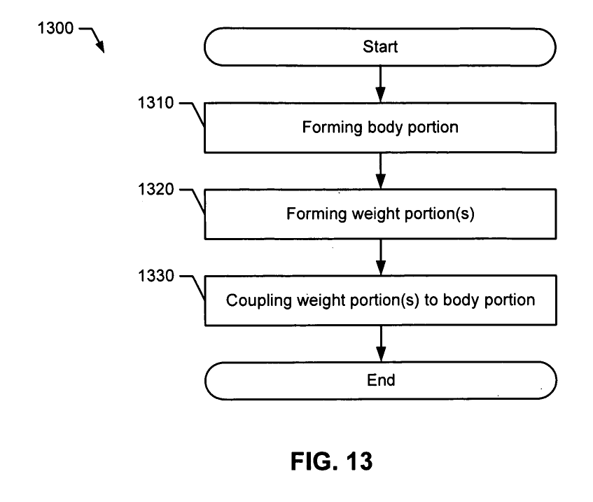

In the example of FIG. 13, a process 1300 to manufacture the golf club head 100 may begin with forming the body portion 110 (block 1310). The body portion 110 may be formed by various casting processes (e.g., an investment casting process). In one example, the body portion 110 may be a cast titanium-based body portion. The process 1300 may form the weight portion(s) 120 (block 1320). The weight portion(s) 120 may be tungsten-based weight portion(s).

The process 1300 may couple the weight portion(s) 120 to the body portion 110 (block 1330). As noted above, the body portion 110 and the weight portion(s) 120 may be dissimilar materials. In one example, the body portion 110 may be a steel-based material whereas the weight portion(s) 120 may be a tungsten-based material. To couple two dissimilar materials together, a brazing process may be used to couple the body portion 110 and the weight portion(s) 120 together. Alternatively, mechanical lock(s) and epoxy may also be used couple the body portion 110 and the weight portion(s) 120 together.

While a particular order of actions is illustrated in FIG. 13, these actions may be performed in other temporal sequences. For example, two or more actions depicted in FIG. 13 may be performed sequentially, concurrently, or simultaneously. Although, the process 1000 may be described above with respect to the golf club head 100, the process 1300 may be applicable to other golf club heads. Further, while the above examples may be described with respect to golf club heads, the methods, apparatus, and articles of manufacture described herein may be applicable to other sports equipment.

While the above examples may describe a particular number of weight portions, the methods, apparatus, and articles of manufacture described herein may include more or less weight portions. In one example, the golf club head 100 may include the hosel weight portion 122 only. In another example, the golf club head 100 may include the toe end weight portion 124 only. In yet another example, the golf club head 100 may include the heel end weight portion 126 only. Alternatively, the golf club head 100 may include only two weight portions of the hosel weight portion 122, the heel end weight portion 124, and the toe end weight portion 126. Further, although the above examples may describe particular shapes of weight portions, the methods, apparatus, and articles of manufacture described herein may include weight portions of other suitable shapes.

Although the above examples may describe particular portions of the golf club head 100, the methods, apparatus, and articles of manufacture described herein may not include one or more portions of the golf club head 100. In one example, the golf club head 100 may not include the perimeter weight portion 170. In another example, the golf club head 100 may not include the notch 180. In yet another example, the golf club head 100 may not include the first cavity 190 and/or the second cavity 195.

While the figures may depict an iron-type club head (e.g., a 1-iron, a 2-iron, a 3-iron, a 4-iron, a 5-iron, a 6-iron, a 7-iron, an 8-iron, a 9-iron, etc.), the apparatus, methods, and articles of manufacture described herein may be applicable other types of club head such s a driver-type club head, a fairway wood-type club head, a hybrid-type club head, a wedge-type club head (e.g., a sand wedge, a pitching wedge, a lob wedge, an n-degree wedge (e.g., 44 degrees (°), 48°, 52°, 56°, 60°, etc.)), a putter-type club head, etc. The apparatus, methods, and articles of manufacture described herein are not limited in this regard.

Although certain example methods, apparatus, and/or articles of manufacture have been described herein, the scope of coverage of this disclosure is not limited thereto. On the contrary, this disclosure covers all methods, apparatus, and/or articles of manufacture fairly falling within the scope of the appended claims either literally or under the doctrine of equivalents.

1. A club head comprising:
a body portion made of a first material, the body portion being associated with a first volume and a first mass; and
one or more weight portions made of a second material, the one or more weight portions being associated with a second volume and a second mass,
wherein the first volume is greater than the second volume, and
wherein the first mass is less than or equal to the second mass.

2. A club head as defined in claim 1, wherein the second volume comprises a volume of less than or equal to 25% of a total volume associated with the club head.

3. A club head as defined in claim 1, wherein the second mass comprises a mass of greater than or equal to 50% of a total mass associated with the club head.

4. A club head as defined in claim 1, wherein the first and second volumes are associated with a ratio of about 3:1.

5. A club head as defined in claim 1, wherein the second mass comprises a mass substantially equal to the first mass.

6. A club head as defined in claim 1, wherein the one or more weight portions is located at or proximate to at least one of a toe end, a heel end, or a hosel portion of the club head.

7. A club head as defined in claim 1, wherein the first material comprises at least one of a steel-based material, a titanium-based material, or an aluminum-based material.

8. A club head as defined in claim 1, wherein the second material comprises a tungsten-based material.

9. A club head as defined in claim 1, wherein the second material comprises a material having a specific gravity of at least 15.

10. A club head as defined in claim 1 further comprising a face portion made of a third material, the face portion being made of a titanium-based material.

11. A club head as defined in claim 1 further comprising a loft angle greater than or equal to ten degrees.

12. A golf club head comprising:
a body portion made partially or entirely of a titanium-based material, the body portion being associated with a first volume and a first mass; and
one or more weight portions made partially or entirely of a tungsten-based material, the one or more weight portions being associated with a second volume and a second mass,
wherein the first volume is more than 50% of a total volume associated with the golf club head, and
wherein the first mass is less than 50% of a total mass associated with the golf club head.

13. A golf club head as defined in claim 12, wherein the second volume comprises a volume less than or equal to 25% of the total volume associated with the golf club head.

14. A golf club head as defined in claim 12, wherein the second mass comprises a mass greater than or equal to 50% of the total volume associated with the golf club head.

15. A golf club head as defined in claim 12, wherein the one or more weight portions is located at or proximate to at least one of a toe end, a heel end, or a hosel portion of the golf club head.

16. A golf club head as defined in claim 12, further comprising a face portion made partially or wholly of a titanium-based material, the face portion being associated with a third volume and a third mass.

17. A golf club head as defined in claim 12, further comprising a loft angle greater than or equal to ten degrees.

18. A golf club head as defined in claim 12, wherein the golf club head comprises at least one of a driver-type golf club head, a fairway wood-type golf club head, a hybrid-type golf club head, an iron-type golf club head, or a putter-type golf club head.

19. A method comprising:
forming a body portion made of a first material, the body portion being associated with a first volume and a first mass;
forming one or more weight portions made of a second material, the weight portion being associated with a second volume and a second mass; and
coupling the one or more weight portions to the body portion,
wherein the first volume is greater than the second volume, and
wherein the first mass is less than or equal to the second mass.

20. A method as defined in claim 19, wherein forming the one or more weight portions comprises forming one or more weight portions associated with a volume of less than or equal to 25% of a total volume associated with the club head.

21. A method as defined in claim 19, wherein forming the one or more weight portions comprises forming one or more weight portions associated with a mass of greater than or equal to 50% of a total mass associated with the club head.

22. A method as defined in claim 19, wherein forming the body portion comprises casting the body portion.

23. A method as defined in claim 19, wherein forming the one or more weight portions comprises brazing the one or more weight portions to the body portion.

24. A method as defined in claim 19, wherein coupling the one or more weight portions comprises coupling the one or more weight portions at or proximate to at least one of a toe end, a heel end, or a hosel portion of the body portion.

25. A method as defined in claim 19 further comprising forming a loft angle greater than or equal to ten degrees.
